(19) United States
(12) Patent Application Publication
(10) Pub. No.: US 2007/0195776 A1
(43) Pub. Date: Aug. 23, 2007

(54) System and method for channeling network traffic

(76) Inventors: Danyang Raymond Zheng, Fremont, CA (US); Ramanathan Jagadeesan, San Jose, CA (US); Bich Tu Nguyen, Los Altos, CA (US); Jack C. Cham, San Leandro, CA (US)

Correspondence Address: MARGER JOHNSON & MCCOLLOM, P.C., 210 SW MORRISON STREET, SUITE 400, PORTLAND, OR, 97204, US

(21) Appl. No.: 11/361,465

(22) Filed: Feb. 23, 2006

(51) Int. Cl. H04L 12/56

(52) U.S. Cl. 370/392; 370/401

(57) ABSTRACT

A method for channeling network traffic is described, which includes identifying, with an agent disposed within a client computer of the network, a portion of the network traffic associated with the client computer that has compliance related interest. The identified compliance interesting traffic portion is encapsulated with a header. Apart from the encapsulated traffic portion, the network traffic is routed according to its designated destination. The interesting traffic portion however is diverted on the basis of the encapsulating header. The diverted traffic portion is channeled for compliance related processing. Upon being channeled, the traffic portion is processed according to a compliance related policy. The processing is performed remotely from the client computer.

### TECHNOLOGY

The present invention relates to networking. More specifically, embodiments of the present invention relate to systems and methods for channeling network traffic.

### BACKGROUND

With the widespread use and growth of networking with computers and communication systems, diverse issues relating to privacy, data security, fiduciary and other concerns have led to the establishment of various laws, rules, regulations, standards for various industries. Encouraging and enforcing compliance with these requirements has become a significant endeavor. Compliance networking has thus become a lively, well established field. Compliance Networking generally refers to methods implemented or action taken at the network to help ensure compliance with the aforementioned laws, rules, regulations, standards, etc.

For instance, confidentiality is an important, perhaps crucial concern to medical patients and social services clients. Thus, health care and social related entities such as commercial, non-profit and governmental hospitals, clinics, professional offices, pharmacies, welfare offices, etc. now typically operate with strict compliance standards in place to protect their patients' and clients' privacy interests. Special attention has been given for networks to assist in meeting such compliance standards.

Similarly, commercial businesses and financial institutions such as banks, credit unions, government revenue offices, etc. now typically operate with strict compliance standards in place to protect their own and their clients' privacy and financial interests. Further, technical, legal, military and other entities now typically operate with strict compliance standards in place to protect the security of their data, code, etc. As these examples illustrate, regulatory compliance has become a significant issue across a broad spectrum of modern activities. In as much as networks have become nearly ubiquitous, compliance networking has also become important in various industries.

Driven by standards and associated regulations, compliance networking equipment (hereinafter compliance equipment) is being used increasingly in an attempt to detect leakage of sensitive information. Just in the examples above for instance, numerous kinds of information are monitored for including intellectual property such as source codes, confidential information such as patient records, social security, credit card and bank account numbers and classified military data. Compliance equipment is useful in monitoring for improper information transmittals as well, such as may include pornography, spam email and the like.

Compliance equipment typically monitors information traffic at gateway network access devices such as routers and switches that reside near the edge of a network. In this conventional configuration, the compliance equipment thus monitors traffic flowing out to and in from the Internet or another network. Compliance equipment thus detects information leakage in outgoing network traffic and records and reports its source, e.g., the source of the information leakage.

In monitoring the traffic, the compliance equipment examines the constituent packets of the traffic and effectively tries to reconstruct what that traffic comprises. In some instances (e.g., installations, situations, configurations, etc.), compliance equipment may effectively perform this function passively, e.g., without necessarily stopping or significantly impeding the information flow. For example, while the compliance equipment may record and report the leakage source, it does not necessarily stop the information from flowing out to the Internet or elsewhere.

However, in other instances, compliance equipment may intercept and capture information traffic deemed to violate a compliance standard. Thus, compliance equipment may actively deter release of violative or other non-compliant traffic. For example, in addition to recording and reporting a leakage source, compliance equipment can actively deter release of non-compliant traffic, e.g., effectively impeding or blocking the traffic from flowing out to and/or in from the network.

Compliance equipment is typically placed either in series with network information traffic, such as between two routers, switches, etc., or in an effectively off-line, tap and/or substantially parallel configuration relative thereto wherein it essentially taps the network traffic to listen thereto (e.g., snoop on, eavesdrop upon, etc.). A variety of kinds of compliance are currently used, each approaching compliance networking issues from a unique perspective and performing a specialized, distinguishable (e.g., differentiable) function related thereto.

Compliance equipment includes three kinds of surveillant systems: detection only devices, forensic devices and prevention devices. Detection only devices examine virtually all network traffic flowing through a gateway and record policy violations that they observe, typically in real time. Forensic devices endeavor to capture everything passing through, typically for off line (e.g., other than real time) scrutiny. Prevention devices block the flow of traffic that violates a compliance policy that they have been programmed to enforce.

While their perspectives and functions may vary, all three kinds of compliance equipment share some commonalities. For instance, each kind (e.g., type) of device is positioned effectively at the edge of a network, such as a business entity's or government agency's firewall, a department's or command's edge router, etc. Typically, the compliance device is practically (e.g., physically) located proximate to premises (e.g., offices, facilities, etc.) of an entity's information technology (IT) or like department. So deployed however, the compliance device is accessible (e.g., internally) to the people therein. This internal exposure can itself pose issues relating to compliance networking, such as where a compliance policy forbids IT personnel from having such proximity and access, e.g., to confidential personal information not releasable outside of a human resources or legal department.

The various types of compliance equipment also all take in virtually all of the traffic that passes through the gateway device, firewall, etc. with which it is associated. Thus to effectively monitor this traffic, their networking interfaces must match the peak bandwidth of the gateway's or firewall's flow through. High traffic volumes can thus raise issues relating to scalability, for instance where compliance equipment is used for surveilling a very large and/or active network.

Currently available compliance equipment has typical traffic handling capacities on the order of 100-400 megabytes. However, large modern corporate, financial, government, academic, scientific and other networks may reach peak traffic levels on the order of gigabits. To effectively handle such high gateway bandwidths, efficiency in performing compliance related processing and other functions can be a significant factor. Efficiency can be especially significant where an active, high bandwidth gateway is monitored with relatively modest compliance equipment.

To achieve performance efficiency, compliance equipment is typically programmed to classify network traffic and to handle its various classifications according to some discriminating scheme. A filtering process can focus the efficient use of compliance equipment bandwidth and processing resources. Thus, certain kinds of traffic are effectively ignored and heightened scrutiny is applied, e.g., in some efficient (e.g., controllable, reserved, economical, etc.) fashion, to other particular kinds. Filter devices used with compliance equipment are typically programmed to function according to a one or more of several parameters.

For instance, filtering may be performed on the basis of protocol, size and/or destination related information such as Internet Protocol (IP) addresses. Thus, traffic conforming to a certain programmed protocol, such as Simple Mail Transfer Protocol (SMTP), or traffic of a certain size characteristic, such as all files below one kilobyte (1 kB), is ignored. Similarly, traffic addressed to a particular range or list of IP subnets, addresses, etc., such as those associated with a competitor, a foreign entity, a suspect designation or destination, etc. is examined more closely.

Given the breadth of the spectrum of modern activities illustrated by the examples above and the sheer volume of network traffic, the number of classifications with which network traffic may be classified is large. However, the wide variety of information that may be “interesting,” e.g., worthy of compliance based scrutiny is also large. Conventional compliance equipment can optimally scan a large volume of various types of traffic, but may then be constrained to detect (e.g., denote for scrutiny, etc.) a relatively few kinds of information. Conversely, conventional compliance equipment can optimally detect a larger variety of information types, but may then be constrained by the volume and varying types of traffic.

This dichotomy in optimizing compliance based traffic surveillance reflects a granularity issue with which conventional compliance surveillance must contend. To program compliance equipment on the basis of a large number of classifications however could be a dauntingly complicated proposition. Typically, the parameters by which filtering is performed are few. However, such coarse granularity can unfortunately result in somewhat inflexible compliance equipment functionality in some instances.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description are not drawn to scale.

FIG. 1 depicts an exemplary system for channeling network traffic, according to an embodiment of the present invention.

FIG. 2 depicts an exemplary packet with an encapsulating header, according to an embodiment of the present invention.

FIG. 3 depicts an exemplary off-line surveillance configuration, according to an embodiment of the present invention.

FIG. 4 depicts an exemplary in-line surveillance configuration, according to an embodiment of the present invention.

FIG. 5 depicts an exemplary tiered control plane for compliance related detection.

FIG. 6 depicts a flowchart of an exemplary process for channeling network traffic, according to an embodiment of the present invention.

FIG. 7 depicts another system for channeling network traffic, according to an embodiment of the present invention.

### DETAILED DESCRIPTION

Exemplary embodiments of a system and method for channeling network traffic are described below. Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims.

Furthermore, in the following detailed description of exemplary embodiments of the present invention, numerous specific details are set forth in order to provide a thorough understanding of the present invention. However, one of ordinary skill in the art will realize that embodiments of the present invention may be practiced without these specific details. In other instances, well-known devices, methods, systems, processes, procedures, components, circuits and apparatus, protocols, standards, etc. have not been described in detail so as not to unnecessarily obscure aspects of the present invention.

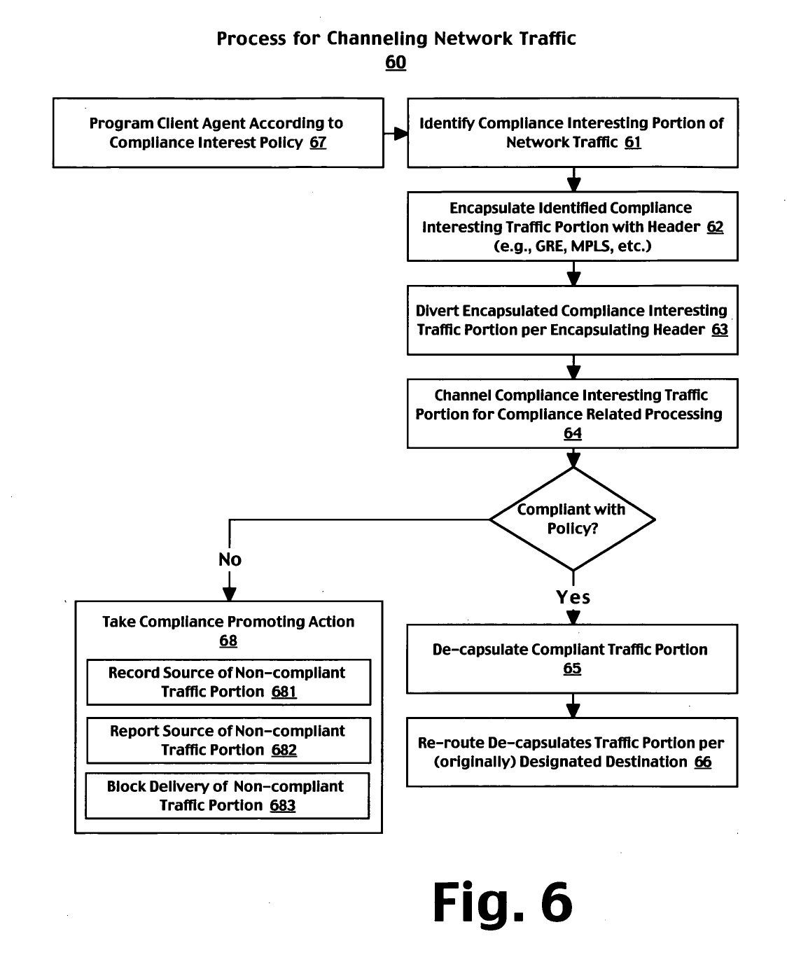

Portions of the detailed description that follows are presented and discussed in terms of processes. Although steps and sequencing thereof are disclosed in flowchart figures herein (e.g., FIG. 6) describing the operations of these processes (e.g., process 60), such steps and sequencing are exemplary. Embodiments of the present invention are well suited to performing various other steps or variations of the steps recited in the flowcharts of the figures herein, and in a sequence, order, etc. other than that depicted and described herein.

Embodiments of the present invention relate to a method and system for channeling network traffic. The method for channeling network traffic includes identifying, with an agent disposed within a client computer of the network, all or a portion of the network traffic associated with the client computer that has compliance related interest. The identified compliance interesting traffic portion is encapsulated with a header. Apart from the encapsulated traffic portion, the network traffic is routed according to its designated destination. The interesting traffic portion however is diverted on the basis of the encapsulating header. The diverted traffic portion is channeled for compliance related processing. Upon being channeled, the traffic portion is processed according to a compliance related policy. The processing is performed remotely from the client computer.

Therefore, embodiments of the present invention allow improvements in the efficiency of compliance networking. In one embodiment, compliance networking related processing is effectively bifurcated into an identification related function and a function related to compliance monitoring, which can include compliance related prophylaxis. The identification function identifies all or portions of network traffic that has compliance related interest (e.g., is compliance interesting) and is performed with an agent disposed within a client computer of the network that is generating network traffic. The monitoring function is performed remotely from the client computer, e.g., with compliance gear (e.g., compliance apparatus), which can include typical, readily available compliance gear or compliance gear especially designed to take advantage of effectively offloading the identification function therefrom, according to the embodiments described herein.

The embodiments described herein thus reduce internal compliance related exposure issues, which can characterize conventional compliance networking approaches. For instance, compliance gear operating according to the embodiments described herein need not look at all network traffic, as conventional compliance gear installations typically do. Instead, they need only apply their monitoring function to a compliance interesting portion of the network traffic. Further, the compliance interesting traffic portion is channeled to a management, security or other entity having cognizance over the compliance related issue associated with the traffic portion's identification as compliance interesting. Thus, the embodiments described herein obviate exposure of the information within the compliance interesting traffic portion to an internal Information Technology (IT), network administration or other entity lacking compliance related cognizance over the information therein.

Further, the bifurcated handling of compliance related processing tasks according to embodiments described herein improve the scalability of compliance gear. The typical volume of network traffic with which it must contend is effectively reduced. In the embodiments described herein, compliance gear bandwidth is freed from the constraint on conventional compliance approaches, wherein the bandwidth of the available compliance gear must typically match the peak network traffic bandwidth. This can have benefits related to processing efficiency and allowing the compliance gear to focus on scrutiny more effectively.

Moreover, the granularity issues with which conventional approaches must typically contend are thus reduced in the embodiments described herein. In as much as embodiments of the present invention distribute the identification of compliance interesting traffic portions among agents disposed with the client computers typically generating a significant part of total network traffic, more kinds of traffic can be designated as interesting. Yet the effectively reduced throughput requirements of the compliance gear, characteristic of the embodiments recited herein, allow more thorough scrutiny to be applied thereto.

Exemplary System for Channeling Network Traffic

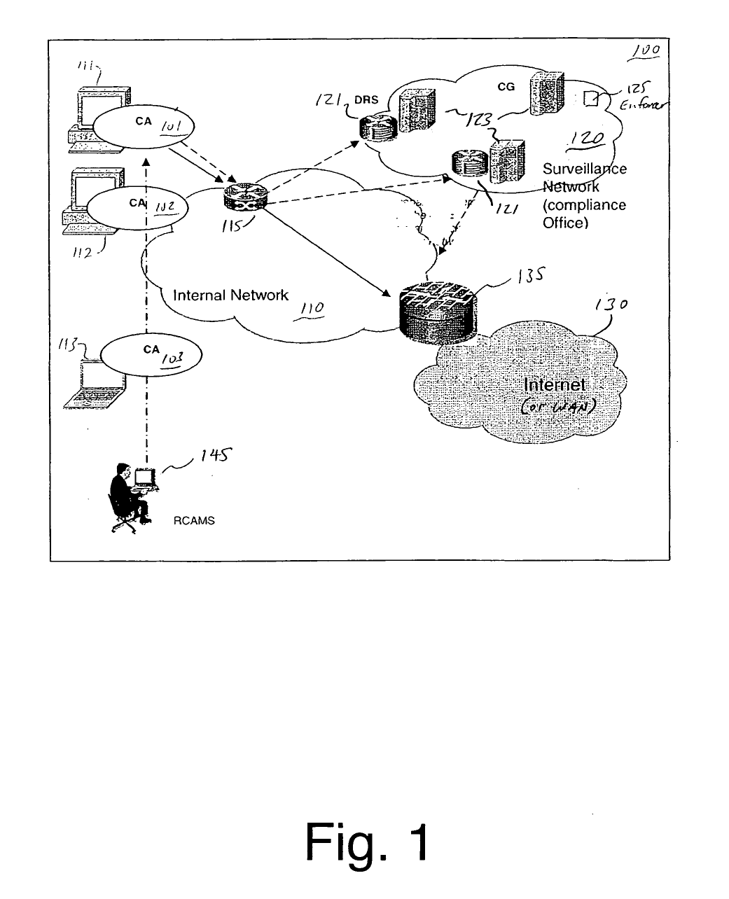

FIG. 1 depicts an exemplary system 100 for channeling traffic in a network 110, according to an embodiment of the present invention. System 100 channels traffic of network 110 that has compliance related interest. In one embodiment, network 110 comprises an internal network of a networked entity (e.g., a business enterprise, government institution, heath care facility, an organization, etc.) that operates with a compliance networking policy in effect.

System 100 includes one or more agents such as agents 101, 102 and 103, which are each disposed within client computers 111, 112 and 113, which are communicatively coupled with network 110 via router 115. Router 115 directs the flow of information traffic, e.g., from the client computers 111-113, through network 110. The router 115 depicted in FIG. 1 can represent one or more routers. In one embodiment, more than one router, represented herein by router 115, routes traffic through network 110.

Client agents 101-103, etc. are programmed for encapsulating a portion of the network traffic that has compliance related interest with a header. For instance, where any of client computers 111-113 generate (e.g., send, transmit, etc.) network traffic that has compliance related interest, one of the agents 101-103 that is associated with (e.g., disposed within) the client computer generating the compliance interesting traffic encapsulates that traffic with an encapsulating header.

In one embodiment, the encapsulating header functions as a tunneling header, with which a packet of the traffic portion is re-routed from its originally designated destination and thus diverted for processing associated with compliance related scrutiny. In one embodiment, the encapsulating header comprises a generic routing encapsulation (GRE) header. In one embodiment, the encapsulating header comprises a header associated with multi-protocol label switching (MPLS). In other embodiments, the encapsulating headers comprise another existing format or a unique format.

The client computers 111, 112 and 113 (e.g., 111-113) comprise computers such as work stations on which an involving party, such as an employee of the networked entity, performs tasks relating to the networked entity which involve transmitting network traffic. In one embodiment, the network traffic comprises IP based traffic, e.g., traffic that is substantially compliant with the Internet Protocol (IP). Client computers 111-113 can be personal computers (PC) or computers similar thereto, compatible with, etc., laptop or other effectively portable computers/devices and/or relatively high performance “workstation” type computers that the involving parties use in day to day or other regular, periodic or frequent networking related activities.

Client agents 101, 102 and 103 (e.g., 101-103) comprise software, hardware or combinations thereof. In one embodiment, one or more of the client agents 101, 102 and 103 comprise software loaded into one or more of client computers 111, 112 and 113, respectively. In one embodiment, one or more of the client agents 101-103 comprise hardware (e.g., so-called intelligent hardware) such as a peripheral component interconnect (PCI) card associated with (e.g., ported to, installed within, etc.) one or more of the client computers 111-113. In another embodiment, one or more of the client agents 101-103 comprise an independent network gateway device, such as a home gateway associated with an involving party.

The client agents 101-103 interact with various applications and/or programs and/or effectively examines files on their respective client computers 111-113, e.g., with a scanning like function. Based on this interaction, scanning etc., the client agents 101-103 determine, based on their programming, whether or not traffic being transmitted by their respective client computers 111-113 includes information that has compliance related interest.

In one exemplary implementation, one or more of the client agents 101-103 scans through the hard drive of their respective client computers 111-113 for content that is effectively suspicious (e.g., interesting) from a compliance related perspective. In one embodiment, such scanning and/or application interaction is performed in a manner analogous to the scanning action performed by some anti-virus (AV) or other virus scan programs, anti-adware programs (software scanning for/countering “advertising-ware,” e.g., adware, malware, scumware, spyware, spybots, etc.) and the like.

Where a suspicious file, document, etc. is found, it is flagged and tracked. Thus, when a networking related application involves the use of a suspicious document or file, the client agents 101-103 detecting the attempt interacts with the application, such as with obtaining tupplets (e.g., pairs of numbers), and begins encapsulating the ensuing transmission with the tunneling header. For example, when an Email exchange program of client computer 112 attempts to attach a document or file identified as being suspicious to an Email message it is sending, client agent 102 interacts with the Email application, obtains the tupplets associated with the message and/or document/file, and encapsulates the Email message (e.g., including the suspicious attachment), with the tunneling header.

One or more of the routers 115 divert a portion of the traffic it handles according to the encapsulating header. The routers 115 route other traffic, e.g., traffic apart from the traffic portion having compliance related interest, according to its designated destination. Thus in one embodiment, router 115 diverts traffic that has compliance related interest but does not divert traffic that does not have compliance related interest (e.g., compliance non-interesting traffic). Instead, router 115 allows such compliance non-interesting traffic flow un-diverted to its designated destination.

The traffic portion that has compliance related interest (e.g., compliance interesting traffic) is diverted by router 115 on the basis of its encapsulating header to one or more second, e.g., compliance related routers 121. Routers 121 are disposed to receive the compliance interesting traffic portion from the first routers 115 based on the encapsulating header attached thereto and to channel the compliance interesting traffic portion for compliance related processing.

In one embodiment, the compliance interesting traffic portion is channeled to one or more compliance apparatus 123, coupled to the compliance related routers 121, for performing compliance related processing thereon. In one embodiment, compliance related routers 121 and compliance apparatus 123 are disposed within a second, e.g., compliance surveillance network 120. In one embodiment, the surveillance load can be balanced amongst (e.g., between) different ones of compliance apparatus 145.

Compliance apparatus 123 effectively performs processing on the compliance interesting traffic portion that is related to compliance monitoring and/or compliance related prophylaxis (e.g., preventive action). In one embodiment, monitoring type processing tends to be somewhat passive in contrast with prevention type processing, which thus tends to be somewhat more active and vice versa. The compliance related processing includes scrutiny of the compliance interesting traffic portion relating to a compliance policy with which compliance apparatus 123 is programmed.

In one embodiment, upon compliance apparatus 123 processing the compliance interesting traffic portion, one or more of the second routers 121 removes the encapsulating headers therefrom. Upon removing the encapsulating header, one or more of the second routers 121 performs a re-routing function on the thus de-encapsulated traffic portion wherein that traffic portion is effectively re-routed, e.g., routed other than according to its designated destination. This re-routing function can correspond to an aspect of the compliance policy.

Thus in one embodiment, upon the compliance related processing wherein the compliance interesting traffic portion is deemed compliant with a significant aspect of the programmed compliance policy, the second router 121 performs its re-routing function wherein the traffic portion is effectively routed to its intended (e.g., designated) destination. In the present embodiment, the compliant traffic portions are eventually routed as intended, though having been temporarily diverted for scrutiny.

However, traffic portions deemed non-compliant (e.g., non-compliant traffic) by its processing can be treated differently, with the varying levels of passivity described above. For instance, the re-routing function for non-compliant traffic can be performed with a monitoring function or with a prophylactic function. In one embodiment, the monitoring function includes recording a source associated with the non-compliant traffic portion and/or reporting the identity of that source. In one embodiment, the prophylactic function includes deterring the re-routing function.

For instance, the traffic portion can be blocked from re-routing according to its intended destination, effectively preventing the release of the non-compliant information therein off of the networks 110 and/or 120. In one embodiment, the non-compliant traffic is re-routed to a compliance policy enforcer 125, such as a network management and/or security entity having cognizance over the compliance policy and related non-compliant traffic.

In one embodiment, a client agent manager 145 is communicatively coupled (e.g., via network 110) with each of the client computers 111-113. The client agent manager 145 can be remote from the client computers 111-113, on which the client agents 101-103 are disposed. In one embodiment, the client agent manager 145 is associated with the compliance policy enforcer 125.

The client agent manager 145 programs each of the client agents 111, 112 and 113 according to a compliance interest policy, effectively pushing compliance policies and associated or other rules, as well as configuration information, down to the client computers 111-113 for programming the client agents 101-103 therewith. The client agent manager 145 can deliver these policies, rules and configuration information to the client computers 111-103 via broadcast, multicast and/or unicast.

The client agents 101, 102 and 103 perform their encapsulating function on the compliance interesting traffic portions according to the compliance interest policy thus programmed. Thus, the compliance related policies and rules, e.g., from the client agent manager 145, contain information that allows the client agents 101, 102 and 103 to determine that a file/document of a traffic portion associated therewith has compliance related interest, and to distinguish this compliance interesting traffic portion from traffic that is not interesting from a compliance related perspective.

For instance, one or more of client agents 101, 102 and 103 may be programmed with a policy/rule that causes the client agents to mark a document/file as compliance interesting that contains a keyword from a programmed list of compliance interesting keywords. Such keywords may be words, phrases, etc. that contain compliance interesting content. In a business entity, such keywords may include “Company Confidential,” “Not for Public Release,” “Not for Outside Dissemination,” “Patent,” “Disclosure,” “Intellectual Property,” “Trade Secret,”“Private,” “Privacy,” Sensitive,” “Source Code,” etc. In a military unit, such keywords may include “Classified,” “Restricted,” “Confidential,” “Secret,” “Top Secret,”“NOFORN” or “Not Releasable to Foreign Nationals,” etc.

Another policy/rule may cause the client agents to scan for a group of numerals that resemble credit card numbers, social security numbers, codes, bank account numbers. Upon finding such a group of numerals, a policy/rule may cause the client agents to mark the document/file that contains them as compliance interesting.

The compliance related policies and rules also contain information that, upon their detection of compliance interesting file/document or associated traffic portion, directs a corresponding appropriate response from the client agents 101-103. For instance, the client agents 101-103 can be programmed so that, upon one of them detecting traffic having compliance interesting (e.g., suspicious) file/document content, the detecting client agent encapsulates the compliance interesting packets associated with that traffic with a destination to which they will be diverted for compliance related scrutiny.

For instance, upon one of client agents 101-103 detecting compliance interesting content containing a keyword string such as “Company Confidential,” the policies/rules suggest or direct the detecting client agent to encapsulate the packets with a destination such as ‘IP a.b.c.d’ that directs (e.g., with tunneling) suspected confidential documents to one of the compliance apparatus 123 that is cognizant over confidential material checking.

Another example involves Email. Upon one of client agents 101-103 detecting compliance interesting content within an Email message, attachment, etc., the policies/rules suggest or direct the detecting client agent to encapsulate the packets with a destination such as ‘IP A.B.C.D’ that directs suspicious Email to one of the compliance apparatus 123 that is cognizant over Email checking.

In one embodiment, alternating or partially alternating IP addresses, corresponding to different ones of multiple compliance apparatus 123, advantageously provides load balancing amongst the various compliance apparatus.

System 100 functions, in one embodiment, with multiple interconnected networks. These multiple networks include the first network 110, through which substantially all traffic associated with the networked entity flows, and which includes the first routers 115. The multiple networks also include the second network 120, coupled with the first network 110 via second routers 121. The second network 120 includes the second routers 121, the compliance apparatus 123 and the compliance enforcer 125 (if used, e.g., for prophylaxis).

In the present embodiment, the first network 110 has a router 135 (e.g., a third router), through which it is coupled and its traffic routed to one or more third networks 130. The third networks 130 are external to the first network 110 and can include the Internet and/or a wide area network (WAN) or multiple WANs. Outgoing traffic from network 110 is routed through the third networks 130 according to its designated destination, which can be deterred therefrom on the basis of the compliance related prophylaxis described above.

Exemplary Encapsulating Header

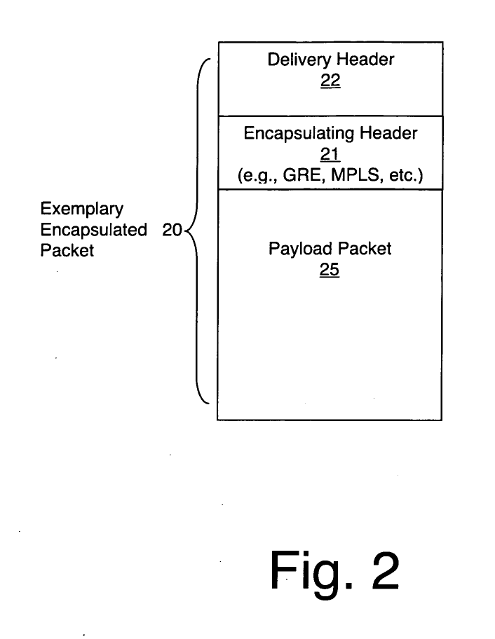

FIG. 2 depicts an exemplary packet 20 with an encapsulating header 21, according to an embodiment of the present invention. In system 100 (FIG. 1) above, the client agents 101-103 are programmed for encapsulating a portion of the network traffic that has compliance related interest with a header. Where any of their respective client computers 111-113 transmit network traffic that has compliance related interest, one of the agents 101-103 that is associated therewith encapsulates that traffic with an encapsulating header 21. In one embodiment, the encapsulating header 21 functions as a tunneling header. As it is encapsulated with the encapsulating header 21, packet 20 comprises an encapsulation (e.g., encapsulated) packet.

Encapsulation packet 20 has a payload packet 25, corresponding to the packet that includes the original destination, e.g., originally designated by involving party using client computer 101, 102 or 103, as well as the source address associated therewith. In one embodiment, encapsulating header 21 comprises a header associated with multi-protocol label switching MPLS. In the embodiment depicted in FIG. 2, encapsulating header 21 comprises an exemplary GRE header, which is substantially compliant with the RFC 2784 Internet standard. In one embodiment, encapsulating header 21 comprises a header associated with a virtual local area network (VLAN). In other embodiments, the encapsulating headers 21 comprise another existing, e.g., standard-based format or a unique, e.g., specifically tailored format.

Thus, in some embodiments, the encapsulation headers 21 function at network layer 3. In other embodiments, the encapsulation headers 21 function at a network layer below level 3. Whichever network layer for which it is composed (e.g., to which it corresponds), the encapsulating header 21 functions to tunnel (e.g., steer, direct, point, divert to, etc.) the packet it encapsulates through the network for compliance related processing, scrutiny, etc. The delivery header 22, associated with the GRE header 21, contains the destination to which the packet 20 is to be diverted, e.g., from its originally designated destination. In one embodiment, the new delivery destination, e.g., to which packet 20 is to be diverted, corresponds to the routers 121.

The routers 121 depicted in FIG. 1 represent routers or network switches that perform a de-capsulation function on encapsulated packets 20, sent thereto from the client computers 111-113 via internal network 110. Upon receipt thereof, the de-capsulating routers/switches (DRS) 121 perform processing thereon, such as de-capsulating them, e.g., stripping the packets of their encapsulating headers. The DRS routers 121 thus represent an endpoint for the channeling (e.g., tunneling) of the packets.

The packets can then be scrutinized for compliance related policy compliance, such as with surveillance apparatus 123. Upon removal of the encapsulating headers 21 (e.g., and their associated delivery headers 22) from the packets 20 diverted to them, the DRS route the packets to their originally designated destinations. Where a prophylactic compliance policy is in effect, payload packets 25 that are found to have other than compliant information content therein, this effective release thereof from diversion can be deterred.

Traffic (e.g., a portion of the traffic flowing through network 110, such as transmitted by one of the client computers 111-113) that is determined by any of the client agents 101-103 to be interesting from a compliance related perspective is deemed to be worthy of further investigation, scrutiny, etc. on the basis of that interesting characteristic. Thus, the encapsulating header 21 is added by a cognizant client agent to provide sufficient information for the packet to be delivered, e.g., via network 110, to an alternate destination from its designated delivery destination, which is designated in the delivery header 23.

Exemplary Surveillance Configurations

In one embodiment, compliance interesting traffic portions are channeled to the compliance apparatus 123, which performs surveillance and/or other compliance related processing thereon that is relatively more comprehensive that that performed by the client agents 101-103. In one embodiment, compliance apparatus 123 effectively performs a relatively more passive surveillance function and in another embodiment, takes more aggressive action such as deterring or blocking non-compliant traffic. The compliance related processing includes scrutiny of the compliance interesting traffic portion relating to a compliance policy with which compliance apparatus 123 is programmed.

The compliance apparatus 123 depicted in FIG. 1 represents compliance gear of various kinds, which include systems, devices and/or equipment for performing a more in depth examination of contents of the traffic portions deemed to be of compliance related interest. It should be appreciated that the level of scrutiny to which the compliance apparatus 123 subjects the compliance interesting traffic portions is more in depth, in contrast to the relatively superficial level of examination performed by any of the client agents 101-103, e.g., in designating a packet or other traffic portion to have compliance related interest.

In determining a traffic portion to have compliance related interest, the client agents 101-103 effectively mark (e.g., flag) the traffic portion for channeling (e.g., tunneling) to the compliance apparatus 123 for scrutiny. Importantly however, traffic apart from the compliance interesting traffic portion (e.g., traffic effectively lacking significant compliance related interest) flows through the network 110 without being diverted.

Thus embodiments of the present invention achieve at least two significant advantages. First, the compliance related scrutiny, analogous to detective work, is minimized on the client agents 101-103, which conserves processing resources that are respectively associated with the client computers 111-113. Second, because embodiments of the present invention divert only compliance interesting portions of the traffic flowing through network 110, the traffic load that the compliance apparatus 123 must handle is significantly reduced.

Exemplary Off-Line Configuration

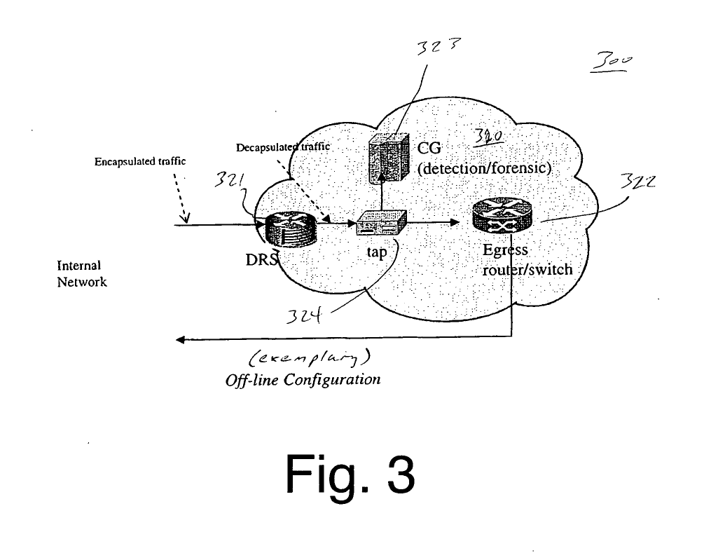

FIG. 3 depicts an exemplary off-line surveillance configuration 300, according to an embodiment of the present invention. Within off-line configuration 300, network 320 comprises a surveillance network that is analogous, similar and/or comparable to surveillance network 120 above. Surveillance network 320 has a DRS 321, which couples to an internal network such as network 110 above and receives therefrom encapsulated traffic portions such as packets, which have compliance related interest. The compliance interesting traffic portion is de-capsulated within DRS 321.

The resulting de-capsulated traffic therefrom flows through a network tap 324, which taps the traffic and provides it, effectively in parallel therewith to the compliance apparatus 323. Compliance apparatus 323 performs a detection and/or forensic function on the de-capsulated traffic portion. In one embodiment, the compliance apparatus 323 records the traffic, such as with effectively capturing and reproducing its compliance interesting content, and/or reporting the traffic, for instance, to a cognizant compliance manager or other compliance enforcing entity such as compliance enforcer 125.

Effectively simultaneous with tapping the traffic, an egress router or switch 322 allows the traffic portion to flow out from the surveillance network 320, to be routed according to its originally designated destination. The compliance interesting traffic portion is thus delayed within network 320 only as long as it takes to flow there through. The surveillance function of compliance apparatus 323 is thus performed on the traffic portion tapped with traffic tap 324 on a somewhat more passive protocol.

The surveillance function performed by compliance apparatus 323 is performed in real time or not in real time (e.g., non-real time forensic analysis).

Exemplary In-Line Configuration

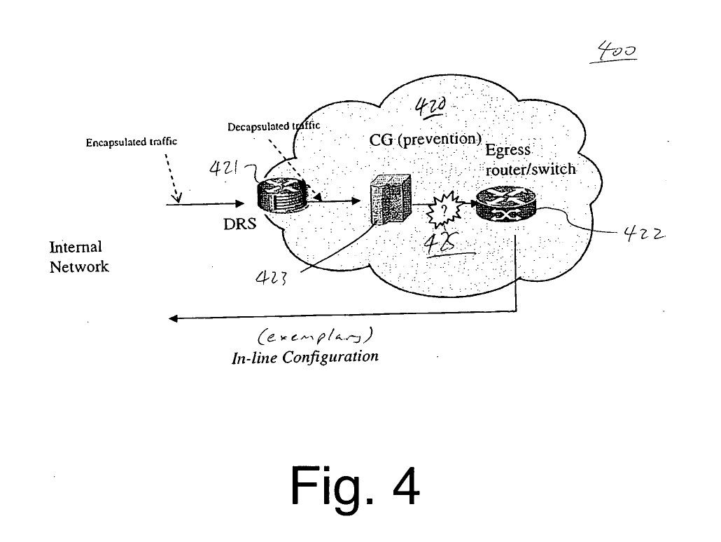

FIG. 4 depicts an exemplary in-line surveillance configuration 400, according to an embodiment of the present invention. Within in-line configuration 400, network 420 comprises a surveillance network that is analogous, similar and/or comparable to surveillance network 120 above. Surveillance network 420 has a DRS 421, which couples to an internal network such as network 110 above and receives therefrom encapsulated traffic portions such as packets, which have compliance related interest. The compliance interesting traffic portion is de-capsulated within DRS 421.

The resulting de-capsulated traffic therefrom flows through compliance apparatus 423. Compliance apparatus 423 performs a less passive preventative (e.g., prophylactic) function on the de-capsulated traffic portion. In one embodiment however, the compliance apparatus 423 also performs detection and forensic functions, along with its prophylactic function. Thus, the compliance apparatus 423 can record the traffic and/or reporting the traffic, for instance, to a cognizant compliance manager or other compliance enforcing entity such as compliance enforcer 125.

With its preventive function however, compliance apparatus 423 can effectively block egress of de-capsulated traffic that its compliance surveillance processing function determines is non-compliant, e.g., violative, of a programmed compliance policy. For instance, traffic that the compliance surveillance processing function determines is compliant with (e.g., non-violative of) a programmed compliance policy is passed on.

An egress router or switch 422 allows compliant traffic portions to flow out from the surveillance network 420, to be routed according to its originally designated destination. The compliance interesting traffic portion is thus delayed within network 420 only as long as it takes to flow there through or is effectively blocked. The surveillance function of compliance apparatus 423 is thus performed on the traffic portion as it flows there through. The surveillance function performed by compliance apparatus 423 is effectively performed in real time.

In one embodiment, compliance apparatus 423 controls egress router/switch 422 to block non-compliant traffic and pass on compliant traffic. In one embodiment, compliance apparatus 423 blocks the non-compliant traffic and passes compliant traffic (e.g., only compliant traffic) to the egress router/switch 422.

Exemplary Tiered Control Plane for Compliance Related Detection

Compliance related policy functions are split between the clients 101-103 on the one hand and the compliance apparatus 123 on the other. This compliance related policy functionality is split, in different embodiments in various ways. In one embodiment, a two-tiered policy structure is used.

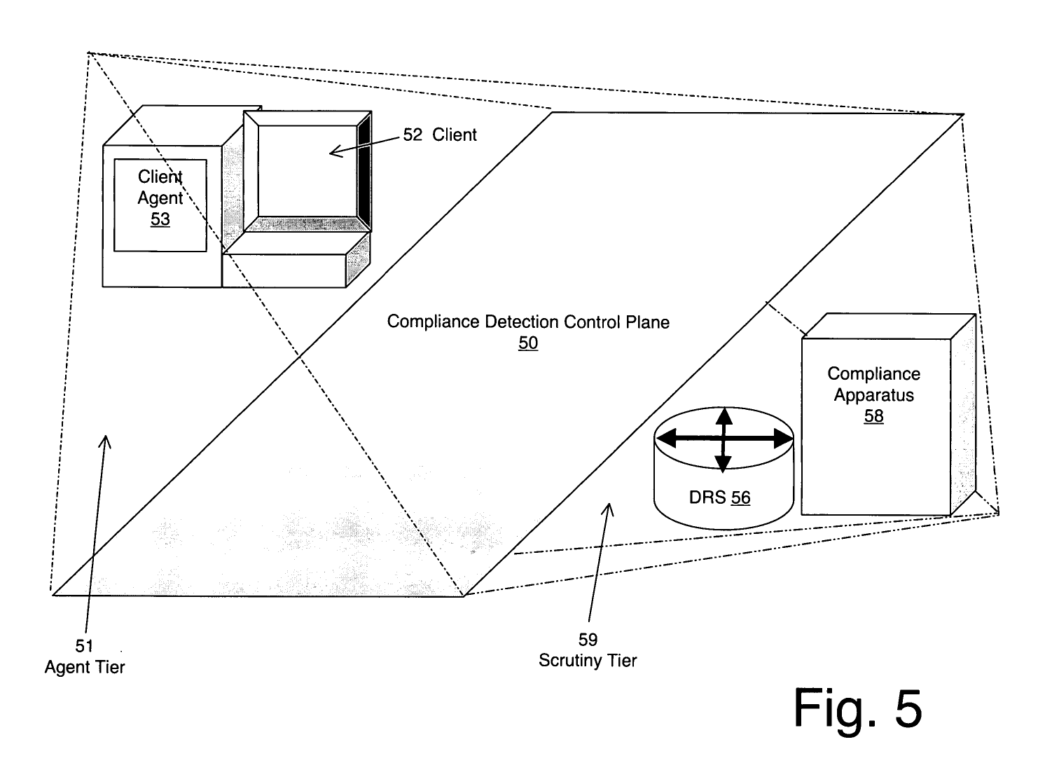

FIG. 5 depicts an exemplary two-tiered control plane 50 for compliance related detection, according to one embodiment of the present invention. Control plane 50 has an agent tier 51 and a scrutiny tier 59. The agent tier 51 includes a client agent 53, disposed within a client computer 52. The scrutiny tier 59 has a DRS 56 and compliance apparatus 58. In one embodiment, client computer 52 and client agent 53 disposed therein function in a manner similar to the function of the analogous client computers 111-113 and client agents 101-103 described above (FIG. 1). Similarly, in one embodiment, DRS 56 and compliance apparatus 58 function in a manner similar to the function of the analogous DRS 121 and compliance apparatus 123, also described above (FIG. 1).

Thus, from the perspective of compliance detection control plane 50, a first tier of compliance related detection is performed at the client computer 52 with the client agent 53 disposed therein. A compliance related policy with which the client agent 53 is programmed is structured such that the detection functionality corresponding thereto has a wide coverage. An exemplary use of this wide ranged agent tier 51 function includes, for instance, detecting the leakage of multiple credit card numbers. Credit card numbers typically range from 14 to 16 digits in length. Thus, an effective agent tier 51 compliance policy for detecting the leakage of multiple credit card numbers can include scanning to detect any content that has, e.g., more than three numbers that have at least 14 digits. An exemplary corresponding scrutiny tier 59 compliance policy can include compliance apparatus 58 examining these numbers, which are diverted from their originally designated destination with a tunneling header to DRS 56. An effective scrutiny tier 59 compliance policy can, for example, include scrutinizing these numbers in detail to ascertain one or more of their mathematical properties, to determine whether the numbers are, indeed, “valid” credit card numbers, at which point monitoring and/or preventive action can be taken in response.

Bifurcating processing and other computational tasks related to compliance detection between the agent tier 51 and a scrutiny tier 59 of control plane 50 allows the compliance apparatus 58 to focus on compliance interesting traffic portions. The processing tasks related to identifying or otherwise designating portions of the total network traffic is effectively off-loaded in the present embodiment to the client agents 53. This can be a useful benefit, unattainable with conventional compliance networking approaches.

With conventional compliance networking approaches, the compliance gear must typically be tasked with both identifying portions of the total network traffic that may have compliance related interest and passing through those that are not particularly compliance interesting, as well as scrutinizing the compliance interesting traffic portions. While scrutinizing the compliance interesting traffic portions may comprise the more computationally intense of the two processing tasks, the sheer volume of network traffic that must be, perhaps somewhat more cursorily but still examined, to identify the compliance interesting portions make that other task a challenge as well.

Thus, the bifurcation of compliance detection processing between the agent tier 51 and a scrutiny tier 59 of control plane 50 according to the present embodiment have at least two advantages, as contrasted with the conventional approaches. The first advantage is the effective unloading of the identification task from the compliance apparatus 58, which allows it to focus on its more processing intensive scrutiny tasks. This has the additional benefit of allowing a more intensive and expectedly more accurate level of scrutiny therewith.

The second advantage is the compliance interesting portion identity screening, shifted to the client agents 53, efficiently allow the identification task to be performed where the network traffic originates, e.g., at the client computers 52. This is not only more efficient and convenient but effectively leverages the larger numbers of client agents 53, disposed in multiple client computers 52 throughout the agent tier 51, to render the identification task more manageable.

Thus, while the client computers 52 are tasked in the present embodiment with some of the computational tasking that, in conventional approaches would be handled by the compliance gear, the identification tasking at any particular client computer 52 scans, e.g., only the traffic it is originating, itself. The identification tasking at the local level of a particular client computer 52 can there pose a effectively insignificant increase in overall computational tasking, related for instance with generating the traffic. This has the benefit of allowing a more intensive and expectedly more accurate level of identification of compliance interesting traffic portions than can be conventionally achieved. Moreover, in one embodiment, the identification tasking comprises a part of that traffic generation, effectively leveraging processing tasks expended in that generation.

Exemplary Process for Channeling Network Traffic

Information traffic in a network may be associated with a client computer of (e.g., coupled to) the network. For instance, the client computer may generate network traffic, such as sending an email, sending a request for a web page, real time and near real time messaging and communications, etc. Some of this client associated traffic, e.g., a portion thereof, may include information that is of compliance related interest, and thus may comprise a compliance interesting traffic portion.

FIG. 6 depicts a flowchart of an exemplary computer implemented process 60 for channeling network traffic, according to an embodiment of the present invention. In one embodiment, process 60 is performed with a computer system acting under control of code encoded on a computer readable medium. In process 60, network traffic is associated with a client computer. Process 60 begins with block 61, wherein a portion of the network traffic associated therewith is identified (e.g., designated, etc.) as having compliance related interest. This compliance interesting identification is a function of an agent disposed within the client computer.

In block 62, the identified compliance interesting traffic portion is encapsulated with a header. In various embodiments, the encapsulating header includes one or more of a generic routing classification encapsulation (GRE) header, a multi-protocol label switching header and another tunneling allowing header. In block 63, the encapsulated compliance interesting traffic portion is diverted, e.g., routed other than according to its designated destination and routed according to its encapsulating header, instead. The rest of the client associated traffic, e.g., apart from the encapsulated compliance interesting traffic portion, is routed according to its designated destination.

In block 64, the compliance interesting traffic portion is channeled (e.g., routed, switched, etc.) according to its encapsulating header, for processing, remotely from the client computer, according to a compliance related policy. Thus, the encapsulating header effectively functions as a tunneling header, which channels the compliance interesting traffic portion for compliance related processing such as compliance scrutiny, examination, inspection, etc. In one embodiment, the encapsulated compliance interesting traffic portion is channeled to compliance scrutiny gear (e.g., apparatus, etc.) via a de-capsulating router, switch, etc. In one embodiment, process 600 can be complete upon channeling the compliance interesting traffic portion for compliance related processing.

In block 65, upon one or more compliance related processing functions deeming (e.g., determining) that the compliance interesting traffic portion complies with a programmed compliance policy, that traffic portion (e.g., one or more packets, etc.) is de-capsulated, wherein the encapsulating header is stripped therefrom. In block 66, upon removing its encapsulating header, the compliant traffic portion is re-routed, this time according to its original designated destination.

In block 67, the client agent is programmed according to a compliance interest policy. The identification and/or encapsulation of compliance interesting traffic is performed according to this compliance interest policy. Initial programming of a client agent is performed prior to it identifying and/or encapsulating compliance interesting traffic. However, client agents can programmed (e.g., re-programmed) at any time. Thus, the compliance interest policy can readily be changed, modified and updated. Client agent programming in one embodiment comprises a function of a client agent manager remote from the client computers on which the client agents are disposed, deployed, etc. In some embodiments, self learning and/or compliance related intelligence information can also be used to program client agents.

In block 68, compliance promoting action is taken upon the compliance related processing deeming (e.g., determining) that the compliance interesting traffic portion is other than compliant with (e.g., violative of) a programmed compliance policy. One or more of various compliance promoting actions can be taken. For instance, in block 681, a source associated with the non-compliant traffic portion is recorded. In block 682, a source associated with the non-compliant traffic portion is reported, e.g., to a cognizant compliance, management and/or security authority. In block 683, routing of the non-compliant traffic portion according to its designated destination is deterred (e.g., impeded, filtered, blocked, sent stripped, sanitized, etc. or the like).

In one embodiment, process 60 is performed with multiple interconnected networks, such as those discussed above, in describing system 100 (FIG. 1). In one embodiment, the multiple networks include a first network, through which substantially all traffic associated with an entity flows.

The first network has one or more first network devices (e.g., routers, switches, etc.), which couple the client computers to the first network, and a second network device. A second network is coupled with the first network via one or more third network devices and has apparatus for performing the processing according to the compliance related policy.

One or more third networks is external to the first network and coupleable thereto via the second network device. Traffic is routed through the third networks according to the original designated destination. The third networks include the Internet and one or more WANs.

In one embodiment, process 60 can be used for managing a network. In one embodiment wherein process 60 is used for managing a network, process 60 comprises a part of a business method wherein consideration such as a fee is charged for the network management or e.g., wherein the management service is provided as a premium, a promotion, a beneficial service, etc. from which a business related benefit is derived.

Another Exemplary System for Channeling Network Traffic

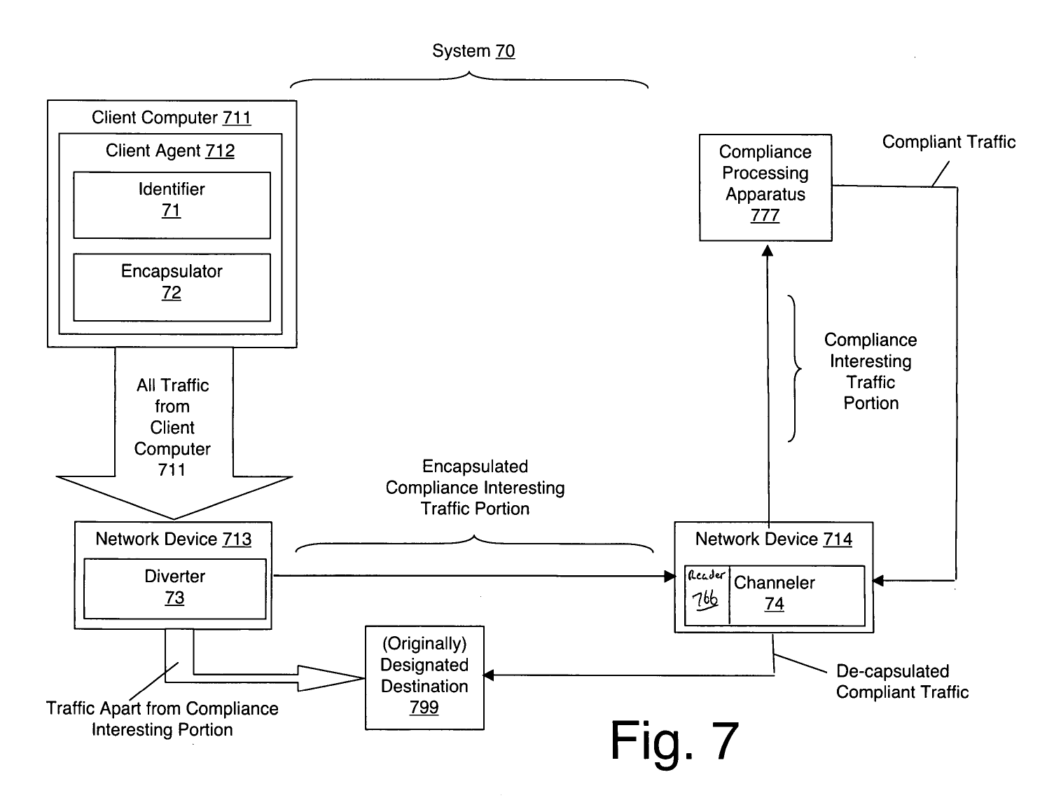

FIG. 7 depicts a system 70 for channeling network traffic, according to an embodiment of the present invention. System 70 includes an identifier 71, which identifies a portion of the network traffic that has compliance related interest, e.g., a compliance interesting traffic portion. The traffic is associated with a client computer 711, which has disposed thereon (e.g., deployed within) a client agent 712. In one embodiment, identifier 71 is a functionality associated with agent 712.

System 70 has an encapsulator 72 associated with the identifier 71, which encapsulates the identified compliance interesting identified traffic portion with an encapsulating header. In one embodiment, encapsulator 72 is also a functionality associated with the client agent 712. In one embodiment, the encapsulation header includes one or more of a GRE header, an MLPS header and/or another tunneling allowing header.

System 70 has a diverter 73, which for instance, upon the client computer sending the traffic, diverts the identified compliance interesting traffic portion according to its encapsulating header, e.g., other than according to its originally designated destination 799. Diverter 73 diverts the compliance interesting traffic portion while allowing routing of traffic apart therefrom according to its designated destination wherein. In one embodiment, diverter 73 is disposed with a network device 713 such as a router, switch, etc. that couples client computer 711 to the network.

System (e.g., apparatus) 70 has a reader 766, which is coupled to diverter 73, for reading the encapsulating header. Apparatus 70 also has a channeler 74 that functions with reader 766. Channeler 74 channels the diverted compliance interesting traffic portion according to its encapsulating header for compliance related processing. In one embodiment, channeler 74 is disposed with a network device 714 such as a router, switch, etc. that is coupled to network device 713 via the network. The traffic portion is processed, remotely from the client computer, according to a compliance related policy. The compliance related processing can include scrutiny, examination, inspection, etc. and can be a passive monitoring activity or a more aggressive preventive activity. In one embodiment, the compliance related processing is performed with compliance apparatus 777. Traffic determined to be compliant with the compliance policy is re-routed to its designated destination 799 upon de-capsulation, e.g., removal of the encapsulating headers.

In summary, the exemplary embodiments described above relate to systems and methods for channeling network traffic. The method includes identifying, with an agent disposed within a client computer of the network, a portion of the network traffic associated with the client computer that has compliance related interest. The identified compliance interesting traffic portion is encapsulated with a header. Apart from the encapsulated traffic portion, the network traffic is routed according to its designated destination. The interesting traffic portion however is diverted on the basis of the encapsulating header. The diverted traffic portion is channeled for compliance related processing. Upon being channeled, the traffic portion is processed according to a compliance related policy. The processing is performed remotely from the client computer.

Embodiments of the present invention, systems and methods for channeling network traffic, are thus described. While the present invention has been described in particular embodiments, it should be appreciated that the present invention should not be construed as limited by such embodiments, but rather construed according to the following claims.

What is claimed is:

1. A method for channeling network traffic, said method comprising:
identifying, with an agent disposed within a client computer of said network, a portion of said network traffic associated with said client computer that has compliance related interest;
encapsulating said identified traffic portion with a header; and
diverting said traffic portion wherein, apart from said identified traffic portion, said traffic is routed according to its designated destination and wherein, upon said diverting, said diverted traffic portion is channeled according to said encapsulating header wherein, upon said channeling, said traffic portion is processed, remotely from said client computer, according to a compliance related policy.

2. The method as recited in claim 1 wherein said encapsulating header, comprises one or more of a generic routing classification header, a multi-protocol label switching header and a tunneling header.

3. The method as recited in claim 1 further comprising, upon said compliance related processing wherein said traffic portion is deemed compliant with a programmed compliance policy, removing said encapsulating header therefrom.

4. The method as recited in claim 3 further comprising, upon said removing said encapsulating header, re-routing said traffic portion according to its designated destination.

5. The method as recited in claim 1 further comprising programming said agent according to a compliance interest policy, wherein one or more of said identifying and said encapsulating is performed according to said compliance interest policy.

6. The method as recited in claim 1 wherein said method is performed with a plurality of interconnected networks, said plurality of networks comprising:
a first network through which substantially all traffic associated with an entity flows wherein said first network comprises:
one or more first routers, wherein said clients are coupled with said first network via said first routers; and
a second router;
a second network coupled with said first network via one or more third routers and wherein said second network comprises apparatus for performing said processing according to said compliance related policy; and
one or more third networks external to said first network and coupleable thereto via said second router, wherein said traffic is routed through said third networks according to said designated destination wherein said third networks comprise one or more of the Internet and a wide area network.

7. The method as recited in claim 6 wherein, upon said compliance related processing wherein said traffic portion is deemed other than compliant with a programmed compliance policy, said method further comprises taking a compliance promoting action wherein said compliance promoting action comprises one or more of:
recording a source associated with said traffic portion;
reporting said source associated with said traffic portion; and
deterring routing of said traffic portion according to its designated destination.

8. An apparatus for channeling network traffic having compliance related interest, said apparatus comprising:
a first network device disposed within said network, for diverting a portion of said traffic according to an encapsulating header and for routing said traffic, apart from said traffic portion, according to its designated destination; and
at least one agent disposed within a client computer of said network and programmed for encapsulating said portion of said traffic with a header, wherein said portion comprises traffic having said compliance related interest, wherein a second network device, disposed to receive said traffic portion from said first network device based on said encapsulating header, channels said traffic portion for compliance related processing.

9. The apparatus as recited in claim 8 wherein said compliance related processing is performed with compliance apparatus coupled to said second network device.

10. The apparatus as recited in claim 8 wherein said encapsulating header, comprises one or more of a generic routing classification header, a multi-protocol label switching header and a tunneling header.

11. The apparatus as recited in claim 8 wherein one or more of said second network devices, upon said compliance related processing, removes said encapsulating header therefrom.

12. The apparatus as recited in claim 11 wherein said compliance related processing comprises scrutiny of said traffic portion relating to said programmed compliance policy.

13. The apparatus as recited in claim 11 wherein said second network device, upon said removing said encapsulating header, performs a re-routing function wherein said second network device re-routes said traffic portion according to its designated destination.

14. The apparatus as recited in claim 13 wherein said programmed compliance policy comprises:
upon said compliance related processing wherein said traffic portion is deemed compliant with a programmed compliance policy, said second network device performs said re-routing function; and
upon said compliance related processing wherein said traffic portion is deemed other than compliant with a programmed compliance policy, said second network devices perform one or more of:
a monitoring function comprising one or more of:
recording a source associated with said traffic portion; and
reporting said source associated with said traffic portion; and
a prophylactic function comprising deterring said re-routing function.

15. The apparatus as recited in claim 8 wherein a client agent manager, communicatively coupled with each said client having one of said agents disposed therein, programs said agent according to a compliance interest policy, wherein said encapsulating is performed according to said compliance interest policy.

16. The apparatus as recited in claim 8 wherein said apparatus functions with a plurality of interconnected networks, said plurality of networks comprising:
a first network through which substantially all traffic associated with an entity flows wherein said first network comprises:
said first network device, wherein said clients are coupled with said first network via said first network devices; and
a third network device;
a second network coupled with said first network via said second network devices and wherein said second network comprises said compliance apparatus; and
one or more third networks external to said first network and coupleable thereto via said third network device, wherein said traffic is routed through said third networks according to said designated destination.

17. The apparatus as recited in claim 16 wherein said third network comprises one or more of the Internet and a wide area network.

18. A method for channeling network traffic, said method comprising:
diverting a portion of said network traffic from its designated destination according to compliance related interest therein, wherein said compliance related interest is indicated by a header that encapsulates said traffic portion, wherein said encapsulating header is added to said traffic portion with an agent disposed within a client computer of said network;
routing said network traffic, apart from said compliance interesting traffic portion, according to its designated destination; and
upon said diverting, channeling said compliance interesting traffic portion for processing according to a compliance related policy.

19. The method as recited in claim 18 wherein said encapsulating header, comprises one or more of a generic routing classification header, a multi-protocol label switching header and a tunneling header.

20. The method as recited in claim 18 further comprising, upon performing said compliance related processing wherein said traffic portion is deemed compliant with a programmed compliance policy, removing said encapsulating header therefrom.

21. The method as recited in claim 20 further comprising, upon said removing said encapsulating header, re-routing said traffic portion according to its designated destination.

22. The method as recited in claim 18 further comprising programming said agent according to a compliance interest policy, wherein one or more of said identifying and said encapsulating is performed according to said compliance interest policy.

23. The method as recited in claim 18 wherein said method is performed with a plurality of interconnected networks, said plurality of networks comprising:
a first network through which substantially all traffic associated with an entity flows wherein said first network comprises:
one or more first routers, wherein said clients are coupled with said first network via said first routers; and
a second router;
a second network coupled with said first network via one or more third routers and wherein said second network comprises apparatus for performing said processing according to said compliance related policy; and
one or more third networks external to said first network and coupleable thereto via said second router, wherein said traffic is routed through said third networks according to said designated destination wherein said third networks comprise one or more of the Internet and a wide area network.

24. The method as recited in claim 23 wherein, upon performing said compliance related processing wherein said traffic portion is deemed other than compliant with a programmed compliance policy, said method further comprises taking a compliance promoting action wherein said compliance promoting action comprises one or more of:
recording a source associated with said traffic portion;
reporting said source associated with said traffic portion; and
deterring routing of said traffic portion according to its designated destination.

25. An apparatus for channeling network traffic having compliance related interest, said apparatus comprising:
a reader for reading a header that encapsulates said compliance interesting traffic portion wherein said encapsulating header is added to said compliance interesting traffic portion with an agent disposed in a client computer of said network and programmed to encapsulate said traffic portion with said header according to said compliance related interest; and
a channeler functional with said reader, for channeling said compliance interesting traffic portion to compliance apparatus coupled to said apparatus for processing said compliance interesting traffic portion according to a compliance policy.

26. The apparatus as recited in claim 25 wherein said compliance interesting traffic portion is diverted to said apparatus according to said encapsulating header and wherein said network traffic, apart from said compliance interesting traffic portion, is routed according to its designated destination.

27. The apparatus as recited in claim 25 wherein said encapsulating header, comprises one or more of a generic routing classification header, a multi-protocol label switching header and a tunneling header.

28. The apparatus as recited in claim 25 wherein said apparatus, upon said compliance related processing, removes said encapsulating header from said traffic portion.

29. The apparatus as recited in claim 28 wherein said compliance related processing comprises scrutiny of said traffic portion relating to said programmed compliance policy.

30. The apparatus as recited in claim 29 wherein said apparatus, upon said removing said encapsulating header, performs a re-routing function wherein said second network device re-routes said traffic portion according to its designated destination.

31. The apparatus as recited in claim 29 wherein said programmed compliance policy comprises:
upon said compliance related processing wherein said traffic portion is deemed compliant with a programmed compliance policy, said second network device performs said re-routing function; and
upon said compliance related processing wherein said traffic portion is deemed other than compliant with a programmed compliance policy, said second network devices perform one or more of:
a monitoring function comprising one or more of:
recording a source associated with said traffic portion; and
reporting said source associated with said traffic portion; and
a prophylactic function comprising deterring said re-routing function.

32. The apparatus as recited in claim 25 wherein a client agent manager, communicatively coupled with each said client having one of said agents disposed therein, programs said agent according to a compliance interest policy, wherein said encapsulating is performed according to said compliance interest policy.

33. The apparatus as recited in claim 25 wherein said apparatus functions with a plurality of interconnected networks, said plurality of networks comprising:
a first network through which substantially all traffic associated with an entity flows wherein said first network comprises:
said first network device, wherein said clients are coupled with said first network via said first network devices; and
a third network device;
a second network coupled with said first network via said apparatus and wherein said second network comprises said compliance apparatus; and
one or more third networks external to said first network and coupleable thereto via said third network device, wherein said traffic is routed through said third networks according to said designated destination.

34. The apparatus as recited in claim 33 wherein said third network comprises one or more of the Internet and a wide area network.

35. A computer readable medium having encoded thereon code for causing a computer system to perform a process for channeling network traffic, said process comprising:
identifying, with an agent disposed within a client computer of said network, a portion of said network traffic associated with said client computer that has compliance related interest;
encapsulating said identified traffic portion with a header;
diverting said traffic portion wherein, apart from said identified traffic portion, said traffic is routed according to its designated destination wherein; and
channeling said diverted traffic portion according to said encapsulating header wherein, upon said channeling, said traffic portion is processed, remotely from said client computer, according to a compliance related policy.

36. A method for managing a network, said method comprising:
programming an agent disposed on a client computer of said network according to a compliance interest policy;
identifying of a portion of said network traffic associated with said client computer that has compliance related interest according to said compliance interest policy;
encapsulating said identified traffic portion with a header;
diverting said traffic portion wherein, apart from said identified traffic portion, said traffic is routed according to its designated destination;
channeling said diverted traffic portion according to said encapsulating header wherein, upon said channeling, said traffic portion is processed, remotely from said client computer, according to a compliance related policy; and
upon said processing, managing further routing of said diverted traffic portion wherein said managing comprises:
upon said traffic portion deemed compliant with said compliance related policy, removing said encapsulating header therefrom wherein said traffic portion is routed according to its designated destination; and
upon said traffic portion deemed other than compliant with said programmed compliance policy, taking a compliance promoting action that comprises one or more of:
recording a source associated with said traffic portion;
reporting said source associated with said traffic portion; and
deterring routing of said traffic portion according to its designated destination.

37. A business method for managing a network, said business method comprising:
programming an agent disposed on a client computer of said network according to a compliance interest policy;
identifying of a portion of said network traffic associated with said client computer that has compliance related interest according to said compliance interest policy;
encapsulating said identified traffic portion with a header;
diverting said traffic portion wherein, apart from said identified traffic portion, said traffic is routed according to its designated destination;
channeling said diverted traffic portion according to said encapsulating header wherein, upon said channeling, said traffic portion is processed, remotely from said client computer, according to a compliance related policy; and
upon said processing, managing further routing of said diverted traffic portion wherein said managing comprises:
upon said traffic portion deemed compliant with said compliance related policy, removing said encapsulating header therefrom wherein said traffic portion is routed according to its designated destination;
upon said traffic portion deemed other than compliant with said programmed compliance policy, taking a compliance promoting action that comprises one or more of:
recording a source associated with said traffic portion;
reporting said source associated with said traffic portion; and
deterring routing of said traffic portion according to its designated destination; and
assessing a fee for said managing.
